(19) United States
(12) Patent Application Publication
(10) Pub. No.: US 2026/0020604 A1
(43) Pub. Date: Jan. 22, 2026

(54) ELECTRONIC ATOMIZATION DEVICE

(71) Applicant: Dongguan Shikai Technology Co., Ltd., Dongguan (CN)

(72) Inventors: Ning Zhong, Dongguan (CN); Junfeng Jiang, Dongguan (CN)

(21) Appl. No.: 18/970,968

(22) Filed: Dec. 6, 2024

(30) Foreign Application Priority Data
Jul. 19, 2024 (CN) 202410972241.6
Jul. 19, 2024 (CN) 202421717083.1

(51) Int. Cl. A24F 40/42; A24F 40/10; A24F 40/30; A24F 40/46; A24F 40/485; H05B 3/42

(52) U.S. Cl. CPC A24F 40/42; A24F 40/10; A24F 40/30; A24F 40/46; A24F 40/485; H05B 3/42

(57) ABSTRACT

The application provides an electronic atomization device including an atomization assembly and a rotating assembly. The atomization assembly is configured to heat and atomize a substance to form an aerosol and includes an upper housing. The rotating assembly is arranged at an end of the upper housing and includes a rotating seat and a fixed seat. The rotating seat and the fixed seat are capable of rotating relative to each other. The rotating seat is fixedly attached to the upper housing. The rotating seat and the fixed seat are sleeved together. The fixed seat is configured to be fixedly attached to a supporting assembly, so that the atomization assembly is capable of rotating relative to the supporting assembly.

### CROSS REFERENCE TO RELATED APPLICATIONS

The present disclosure claims priorities to Chinese patent application No. 202410972241.6, filed on Jul. 19, 2024, and Chinese patent application No. 202421717083.1, filed on Jul. 19, 2024, the entire contents of which are incorporated herein by reference.

### TECHNICAL FIELD

The present disclosure relates to the field of electronic atomization technologies, and in particular to an electronic atomization device.

### BACKGROUND

In the related art, a multi-flavor electronic atomization device usually includes a plurality of cartridges and a rotating structure that may rotate around a central shaft. The rotating structure may be fixed vertically via a screw engaged with the rotating structure and the central shaft, and may rotate horizontally around the central shaft. The rotating structure may accommodate the plurality of cartridges. However, the electronic atomization device has the problem that the rotating structure occupies a large space, which leads to a low utilization rate of a liquid storage space of the electronic atomization device.

### SUMMARY OF THE DISCLOSURE

In a first aspect, the present disclosure provides an electronic atomization device including an atomization assembly and a rotating assembly. The atomization assembly is configured to heat and atomize a substance to form an aerosol and includes an upper housing. The rotating assembly is arranged at an end of the upper housing and includes a rotating seat and a fixed seat. The rotating seat and the fixed seat are capable of rotating relative to each other. The rotating seat is fixedly attached to the upper housing. The rotating seat and the fixed seat are sleeved together. The fixed seat is configured to be fixedly attached to a supporting assembly, so that the atomization assembly is capable of rotating relative to the supporting assembly.

In a second aspect, the present disclosure provides an electronic atomization device including an atomization assembly and a rotating assembly. The atomization assembly including a liquid cup, an upper housing, and a plurality of atomization cores. The liquid cup is fixedly mounted in the upper housing and is defined with at least one liquid-storage chamber for storing the substance. The plurality of atomization cores are configured to be in fluid communication with the liquid-storage chamber to heat and atomize a substance to form an aerosol. The rotating assembly is arranged at an end of the upper housing and includes a rotating seat and a fixed seat. The rotating seat and the fixed seat are capable of rotating relative to each other. The rotating seat is fixedly attached to the upper housing. The rotating seat and the fixed seat are sleeved together. The fixed seat is configured to be fixedly attached to a supporting assembly, so that the atomization assembly is capable of rotating relative to the supporting assembly.

In a third aspect, the present disclosure provides an electronic atomization device including an atomization assembly, a rotating assembly, and a supporting assembly. The atomization assembly is configured to heat and atomize a substance to form an aerosol and includes an upper housing. The rotating assembly is arranged at an end of the upper housing and includes a rotating seat and a fixed seat. The rotating seat and the fixed seat are capable of rotating relative to each other. The rotating seat is fixedly attached to the upper housing. The rotating seat and the fixed seat are sleeved together. The supporting assembly includes a lower housing and a frame fixed in the lower housing. The lower housing is sleeved on an end of the rotating seat away from the atomization assembly. The frame is fixedly connected to the fixed seat, so that the atomization assembly is capable of rotating relative to the supporting assembly.

### BRIEF DESCRIPTION OF THE DRAWINGS

FIG. 1 is a schematic exploded view of an electronic atomization device according to some embodiments of the present disclosure.

FIG. 2 is a schematic cross-sectional view of the electronic atomization device shown in FIG. 1 according to some embodiments of the present disclosure.

FIG. 3 is a schematic upward view of a liquid cup of the electronic atomization device shown in FIG. 1 according to some embodiments of the present disclosure.

FIG. 4 is a schematic main view of a rotating seat of the electronic atomization device shown in FIG. 1 according to some embodiments of the present disclosure.

FIG. 5 is a schematic cross-sectional view of the rotating seat shown in FIG. 4 according to some embodiments of the present disclosure.

FIG. 6 is a schematic structural view of a fixed seat of the electronic atomization device shown in FIG. 1 according to some embodiments of the present disclosure.

FIG. 7 is a schematic structural view of a rotating seat mounted with a fixed seat of the electronic atomization device shown in FIG. 1 according to some embodiments of the present disclosure.

FIG. 8 is a schematic enlarged view of a region A shown in FIG. 7 according to some embodiments of the present disclosure.

FIG. 9 is a schematic structural view of an electrically conductive pin of the electronic atomization device shown in FIG. 1 according to some embodiments of the present disclosure.

FIG. 10 is a schematic exploded view of an electronic atomization device according to some embodiments of the present disclosure.

FIG. 11 is a schematic exploded view of an electronic atomization device according to some embodiments of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are merely some of the embodiments of the present disclosure, rather than all of the embodiments. All other embodiments obtained by persons of ordinary skill in the art according to the embodiments of the present disclosure without making creative efforts belong to the protection scope of the present disclosure.

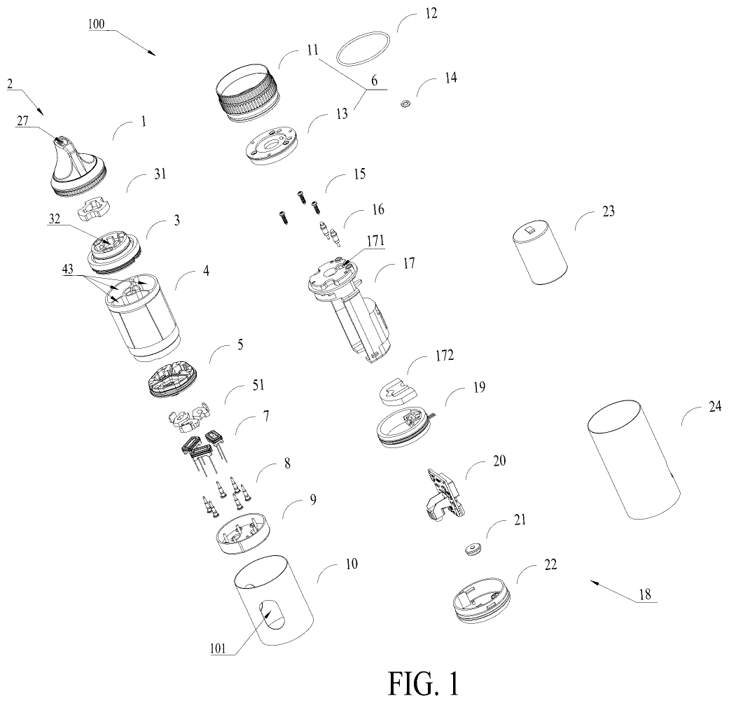

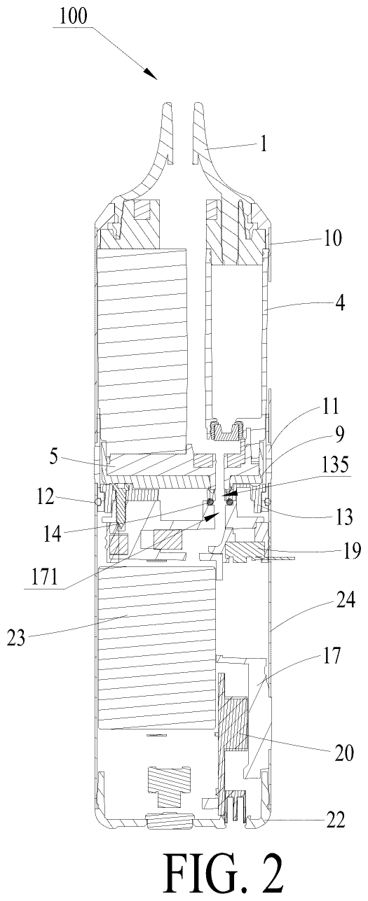

FIG. 1 is an exploded view of an electronic atomization device 100 according to some embodiments of the present disclosure, and FIG. 2 is a cross-sectional view of the electronic atomization device 100 as shown in FIG. 1 according to some embodiments of the present disclosure. As shown in FIG. 1 and FIG. 2, the embodiments of the present disclosure provide an electronic atomization device 100 including an atomization assembly 2 and a rotating assembly 6. The atomization assembly 2 is configured to heat and atomize a substance to form an aerosol. In some embodiments, the substance includes a substance to be atomized such as an aerosol generating substance, which may be tobacco oil, liquid medicine, and etc. The atomization assembly 2 includes an upper housing 10, and the rotating assembly 6 is arranged at an end of the upper housing 10. The rotating assembly 6 may be partially accommodated in the upper housing 10, or may be completely accommodated in the upper housing 10. The rotating assembly 6 includes a rotating seat 11 and a fixed seat 13. The rotating seat 11 and the fixed seat are capable of rotating relative to each other. The rotating seat 11 and the fixed seat 13 are sleeved together. In some embodiments, the rotating seat 11 and the fixed seat 13 are mutually sleeved, and the rotating seat 11 may be arranged around the fixed seat 13, or the fixed seat 13 may be arranged around the rotating seat 11. The rotating seat 11 is fixedly attached to the upper housing 10. The fixed seat 13 is configured to be fixedly attached to a supporting assembly 18. The atomization assembly 2 is capable of rotating relative to the supporting assembly 18. In some embodiments, the supporting assembly 18 may be a supporting structure for supporting the atomization assembly 2 and the rotating assembly 6, or may be a power supply structure for supplying power to the atomization assembly 2. In some embodiments, the term “mutually sleeved” or “sleeved together” means that the rotating seat 11 is rotatably connected but axially fixedly connected to the fixed seat 13.

In these embodiments, the upper housing 10 of the atomization assembly 2 is fixedly connected to the rotating seat 11 of the rotating assembly 6, and the supporting assembly 18 is fixedly connected to the fixed seat 13 of the rotating assembly 6. In this way, the atomization assembly 2, the rotating assembly 6, and the supporting assembly 18 are connected in sequence. The rotating seat 11 and the fixed seat 13 are mutually sleeved and are capable of rotating relative to each other, so that the atomization assembly 2 and the supporting assembly 18 rotate relative to each other. The rotating assembly 6 may effectively reduce its own occupied space, thereby improving the space utilization rate of the electronic atomization device 100.

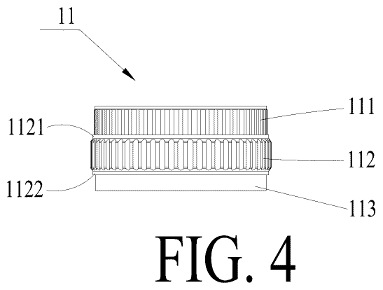

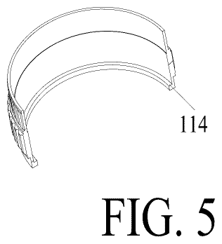

FIG. 4 is a main view of a rotating seat 11 of the electronic atomization device 100 as shown in FIG. 1 according to some embodiments of the present disclosure, and FIG. 5 is a cross-sectional view of the rotating seat 11 as shown in FIG. 4 according to some embodiments of the present disclosure. As shown in FIG. 4 and FIG. 5, in some embodiments, the rotating seat 11 includes an upper connecting portion 111 and a lower connecting portion 113. The upper connecting portion 111 and the lower connecting portion 113 may be connected as a whole. The upper connecting portion 111 is fixedly attached to the upper housing 10. In some embodiments, the upper connecting portion 111 may be fixedly attached to the upper housing 10 by means of gluing, clamping, threading, or screwing, etc. The lower connecting portion 113 has a first step portion 114. The first step portion 114 includes a first surface. The fixed seat 13 includes a base 131 and a second step portion 132 arranged on the base 131. The second step portion 132 includes a second surface. The second surface of the second step portion 132 contacts the first surface of the first step portion 114, and the first step portion 114 and the second step portion 132 are capable of rotatably sliding relative to each other along the first surface and the second surface. The rotating seat 11 and the fixed seat 13 rotate relative to each other.

In these embodiments, the first surface of the first step portion 114 faces the atomization assembly 2. The second surface of the second step portion 132 faces the supporting assembly 18. The first surface of the first step portion 114 contacts the second surface of the second step portion 132. Through the first step portion 114 and the second step portion 132, the rotary butt of the rotating seat 11 and the fixed seat 13 may be realized. Compared with a rotary connection mode of using a middle-supporting shaft and a screw for fixing in the related art, the present disclosure improves the space utilization rate of the atomization assembly 2, and has high degree of solidity and reliability.

In some embodiments, the first step portion 114 is arranged on an inner side of the lower connecting portion 113, the second step portion 132 is arranged on an outer edge of the base 131. The rotating seat 11 is sleeved on an outside of the fixed seat 13. The rotating assembly 6 may be completely accommodated in the upper housing 10.

In some embodiments, the first step portion 114 is arranged on an outside of the lower connecting portion 113, the second step portion 132 is arranged on an inner side of the base 131. The fixed seat 13 is sleeved on an outside of the rotating seat 11. The rotating assembly 6 may be partially accommodated in the upper housing 10, and the lower connecting portion 113 is exposed from the upper housing 10.

As shown in FIG. 5, in some embodiments, the first step portion 114 may be arranged at an end of the lower connecting portion 113 away from the upper connecting portion 111. The first step 114 may be made of a material with a high degree of hardness, such as metal. In some other embodiments, the first step portion 114 may be arranged at an end of the lower connecting portion 113 close to the upper connecting portion 111. The first step 114 may also be made of other materials, such as hard plastic. The first step portion 114 may also be arranged at any position between two ends of the lower connecting portion 113, and is not limited herein.

As shown in FIG. 4 and FIG. 5, in some embodiments, the rotating seat 11 further includes a middle portion 112. The upper connecting portion 111, the middle portion 112, and the lower connecting portion 113 are connected in sequence. In some embodiments, the upper connecting portion 111, the middle portion 112, and the lower connecting portion 113 are integrally formed. The middle portion 112 is convex relative to the upper connecting portion 111 and the lower connecting portion 113. The middle portion 112 includes a first convex edge 1121 close to the upper connecting portion 111 and a second convex edge 1122 close to the lower connecting portion 113. The end of the upper housing 10 is adjacent to or contacts the first convex edge 1121. The second convex edge 1122 is configured to be adjacent to or contact the supporting assembly 18. It is understandable that the upper connecting portion 111 is accommodated in the upper housing 10, the lower connecting portion 113 extends into the supporting assembly 18. The middle portion 112 is exposed from the upper housing 10 and the supporting assembly 18, and is located between the upper housing 10 and the supporting assembly 18.

In some embodiments, the rotating seat 11 may be made of a material such as aluminum alloy, which is convenient for processing and has a certain strength. The fixed seat 13 may be made of a material such as polyoxymethylene (POM), which has a high degree of reliability. In this way, the rotation between the rotating seat 11 and the fixed seat 13 is more reliable.

In some embodiments of the present disclosure, a user can rotate the rotating seat 11 by the middle portion 112, so that the rotating seat 11 is capable of driving the atomization assembly 2 to rotate relative to the fixed seat 13, thereby realizing the relative rotation of the atomization assembly 2 and the supporting assembly 18.

In some embodiments, an outer surface of the middle portion 112 is provided with a concave-convex pattern. The concave-convex pattern arranged on the outer surface of the middle portion 112 may effectively increase the friction force between the user and the middle portion 112 when the user is in contact with the middle portion 112, improve the feeling of rotation, and enable the user to more easily realize the rotation of the atomization assembly 2 relative to the supporting assembly 18. The concave-convex pattern may also improve the aesthetics of the electronic atomization device 100.

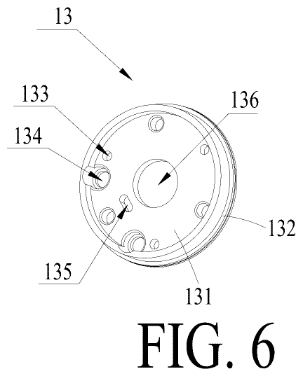

FIG. 6 is a schematic structural view of a fixed seat 13 of the electronic atomization device 100 as shown in FIG. 1 according to some embodiments of the present disclosure. As shown in FIG. 1 and FIG. 6, in some embodiments, the fixed seat 13 is defined with two or more first holes 133. The fixed seat 13 includes a first side toward the atomization assembly 2. The first holes 133 are evenly or unevenly distributed on the first side of the fixed seat 13. In some embodiments, the base 131 includes a third surface toward the atomization assembly 2. The first holes 133 are formed on the third surface of the base 131. The fixed seat 13 is configured to be fixedly attached to the supporting assembly 18 by fixing members 15 passing through the first holes 133 and being fixedly mounted on the supporting assembly 18.

As shown in FIG. 6, in some embodiments, the base 131 may be provided with three first holes 133. The three first holes 133 may be evenly or unevenly distributed on the base 131. An end of each of the fixing members 15 may contact the third surface of the base 131, and the other end of each of the fixing members 15 may pass through a corresponding first hole 133 and be fixedly mounted on the supporting assembly 18, thereby realizing the fixed connection between the fixed seat 13 and the supporting assembly 18. In some embodiments, the fixing members 15 may be fasteners such as screws, bolts, etc. that cooperate with the first holes 133 to realize fixing. Through the fixing members 15 and the first holes 133, the supporting assembly 18 and the rotating assembly 6 are firmly connected and are not easy to have the risk of being broken apart.

As shown in FIG. 1, in some embodiments, the supporting assembly 18 includes two spring-loaded pins 16. The atomization assembly 2 further includes a plurality of atomization cores 7 and a plurality of pairs of electrically conductive pins 8. Each of the atomization cores 7 is electrically connected to a corresponding pair of electrically conductive pins 8. In some embodiments, the spring-loaded pins 16 include electrical pogo pins. The plurality of pairs of electrically conductive pins 8 are arranged on a side of the plurality of atomization cores 7 close to the supporting assembly 18. Through the relative rotation of the rotating seat 11 and the fixed seat 13, the two spring-loaded pins 16 are capable of selectively contacting with a pair of electrically conductive pins 8 in the plurality of pairs of electrically conductive pins 8, so that the spring-loaded pins 16 is capable of being electrically connected to one of the atomization cores 7 in the plurality of atomization cores 7. In some embodiments, the atomization cores 7 may be ceramic atomization cores, cotton cores, and etc., or may also be flat plate atomization cores. In some embodiments, the atomization cores 7 may be flat plate ceramic atomization cores, which may effectively improve the atomization efficiency. The term “a plurality of” means two or more.

In some embodiments, the number of pairs of the electrically conductive pins 8 is the same as the number of atomization cores 7. The plurality of atomization cores 7 may be evenly or unevenly distributed, and the plurality of pairs of electrically conductive pins 8 are arranged accordingly. A contour of the rotating seat 11 is in a shape of a circular ring. The two spring-loaded pins 16 extend into the rotating seat 11 through the fixed seat 13. Through the relative rotation of the rotating seat 11 and the fixed seat 13, the two spring-loaded pins 16 may selectively contact with one pair of electrically conductive pins 8 in the plurality of pairs of electrically conductive pins 8, thereby realizing the conduction between the spring-loaded pins 16 and the electrically conductive pins 8. The two spring-loaded pins 16 may not be in contact with any electrically conductive pin 8 to realize disconnection between the spring-loaded pins 16 and the electrically conductive pins 8. When the two spring-loaded pins 16 are in contact with a pair of electrically conductive pins 8, the two spring-loaded pins 16 are electrically connected to an atomization core 7 corresponding to the pair of electrically conductive pins 8.

In some embodiments, the atomization assembly 2 may include three atomization cores 7 and three pairs of electrically conductive pins 8. The number of atomization cores 7 and the number of pairs of electrically conductive pins 8 may also be set according to the actual situation, and are not limited herein.

As shown in FIG. 1 and FIG. 2, in some embodiments, the atomization assembly 2 further includes a liquid cup 4 fixedly mounted in the upper housing 10. The liquid cup 4 is arranged on a side of the atomization cores 7 away from the supporting assembly 18. The liquid cup 4 is defined with at least one liquid-storage chamber 43 for storing the substance. The plurality of atomization cores 7 are configured to be in fluid communication with the liquid-storage chamber 43.

In some embodiments, the liquid cup 4 may be defined with one liquid-storage chamber 43, and the atomization assembly 2 may include two or more atomization cores 7. The two or more atomization cores 7 are all configured to be in fluid communication with the liquid-storage chamber 43. The atomization cores 7 may be configured to have different heating powers, thereby realizing that the substance in the liquid-storage chamber 43 is heated and atomized to form different amounts of aerosol.

In some embodiments, the liquid cup 4 may be defined with two or more liquid-storage chambers 43. The two or more liquid-storage chambers 43 may respectively store different substances with different flavors, thereby realizing the diversification of flavors of the electronic atomization device 100.

In some embodiments, an outer wall of each of the liquid-storage chambers 43 has a transparent region. The upper housing 10 is defined with a visual window 101 corresponding to the transparent region. The transparent region is arranged on the outer wall of the liquid-storage chamber 43, and the visual window 101 is defined on the upper housing 10. In this way, the user can directly observe the substance in the liquid-storage chambers 43 through the visual window 101, which is convenient for the user to know the usage situation of the substance. In some embodiments, the liquid-storage chambers 43 may be made of transparent materials.

In some embodiments, the atomization assembly 2 may also include a plurality of cartridges (not shown). The plurality of cartridges may be accommodated in the liquid cup 4. Each of the cartridges is defined with a liquid-storage chamber and has an atomization core. The atomization core is configured to heat and atomize the substance in a corresponding liquid-storage chamber. When the substance in one of the cartridges is exhausted or under other necessary conditions, the cartridge may be pulled out from an end of the liquid cup 4, and a new cartridge may be inserted into the liquid cup 4 through the same end to complete replacement of the cartridge.

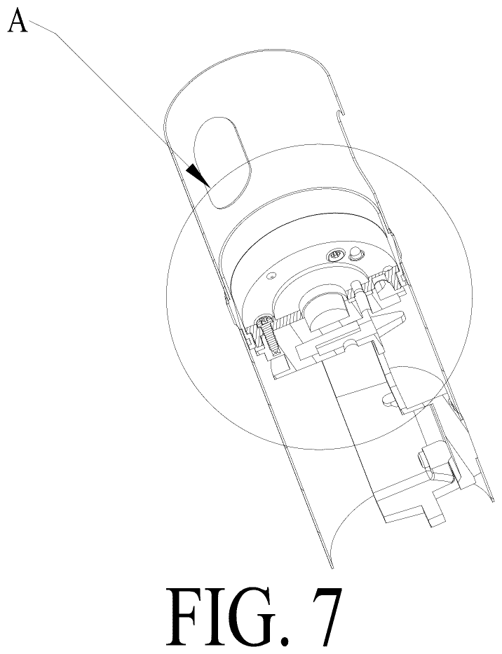

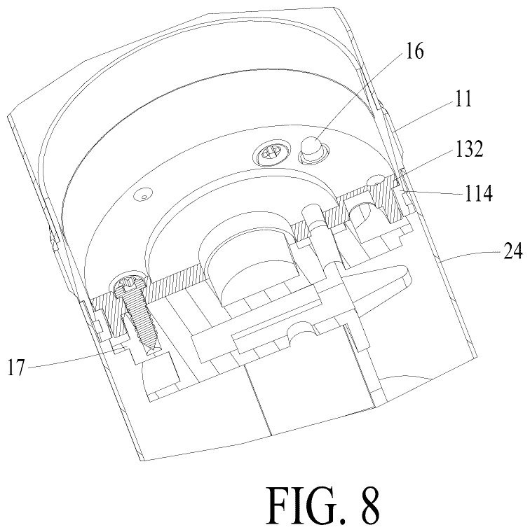

FIG. 7 is a schematic structural view of a rotating seat 11 mounted with a fixed seat 13 of the electronic atomization device 100 as shown in FIG. 1 according to some embodiments of the present disclosure, and FIG. 8 is an enlarged view of a region A shown in FIG. 7 according to some embodiments of the present disclosure. As shown in FIG. 1 and FIG. 6 to FIG. 8, in some embodiments, the fixed seat 13 is further defined with second holes 134. Each of the spring-loaded pins 16 passes through one of the second holes 134 and protrudes on a surface of the fixed seat 13. The atomization assembly 2 further includes a first cover 9. The liquid cup 4 includes a bottom end toward the rotating assembly 6. The first cover 9 is sleeved on the bottom end. The plurality of pairs of electrically conductive pins 8 are fixedly mounted on the first cover 9.

In some embodiments, the fixed seat 13 is defined with two second holes 134 corresponding to the two spring-loaded pins 16 respectively. The two spring-loaded pins 16 pass through the second hole 134 respectively and protrude on the third surface of the base 131 along a direction close to the atomization assembly 2, in order to contact with a pair of electrically conductive pins 8 in the plurality of pairs of electrically conductive pins 8.

As shown in FIG. 1, in some embodiments, the atomization assembly 2 further includes a liquid cup sealing-member 5 arranged between the liquid cup 4 and the first cover 9. The liquid cup sealing-member 5 includes a first end toward the liquid cup 4. The first end of the liquid cup sealing-member 5 is configured to seal the bottom of the liquid cup 4. In some embodiments, the liquid cup sealing-member 5 may be made of a silicone material.

In some embodiments, a first liquid-absorbing member 51 is arranged in the liquid cup sealing-member 5. The liquid cup sealing-member 5 includes a second side toward the first cover 9. The first liquid-absorbing member 51 is arranged on the second side of the liquid cup sealing-member 5. The first liquid-absorbing member 51 may be a liquid-absorbing cotton, etc. The liquid cup sealing-member 5 is configured to prevent the substance stored in the liquid-storage chambers 43 from leaking from the liquid cup 4 to the rotating assembly 6.

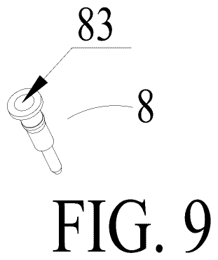

FIG. 9 is a schematic structural view of an electrically conductive pin 8 of the electronic atomization device 100 as shown in FIG. 1 according to some embodiments of the present disclosure. As shown in FIG. 9, in some embodiments, at least one electrically conductive pin 8 of a pair of electrically conductive pins 8 is defined with a positioning hole 83. The electrically conductive pin 8 includes a bottom side toward the rotating assembly 6. The positioning hole 83 is defined on the bottom side. When the two spring-loaded pins 16 are in contact with a pair of electrically conductive pins 8 in the plurality of pairs of electrically conductive pins 8, at least one spring-loaded pin 16 of the two spring-loaded pins 16 extends into the positioning hole 83 of the electrically conductive pin 8.

In these embodiments, the positioning hole 83 is recessed along a direction away from the rotating assembly 6. When the spring-loaded pin 16 is rotated to extend into the positioning hole 83 of the electrically conductive pin 8, the spring-loaded pin 16 may be electrically connected to the electrically conductive pin 8, and the spring-loaded pin 16 may be fixed to the electrically conductive pin 8 simultaneously, thereby realizing the positioning function. In some embodiments, the spring-loaded pins 16 may be spring electrodes, and there is no need to arrange positioning marbles additionally, which has the advantages of convenient installation and simple structure.

In some embodiments, only one electrically conductive pin 8 of each pair of electrically conductive pins 8 is defined with the positioning hole 83, thereby enhancing the smoothness and rotational reliability of the rotating seat 11 and the fixed seat 13 when the rotating seat 11 and the fixed seat 13 rotate relative to each other.

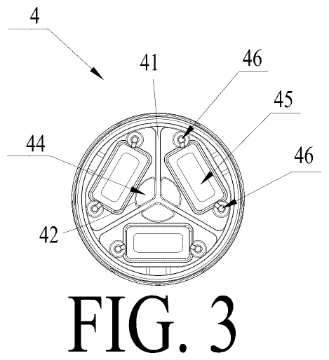

FIG. 3 is an upward view of a liquid cup 4 of the electronic atomization device 100 as shown in FIG. 1 according to some embodiments of the present disclosure. As shown in FIG. 1 and FIG. 3, in some embodiments, the liquid cup 4 includes a plurality of first dividing walls 41, a side wall, and a bottom wall. The first dividing walls 41 and the side wall and the bottom wall of the liquid cup 4 are enclosed to form a plurality of liquid-storage chambers 43. The plurality of atomization cores 7 and the plurality of liquid-storage chambers 43 are arranged one to one, i.e., each of the plurality of liquid-storage chambers 43 accommodates one of the plurality of atomization cores 7.

In these embodiments, the plurality of first dividing walls 41 divide a space of the liquid cup 4 into the plurality of liquid-storage chambers 43, so that each of the liquid-storage chambers 43 is independently arranged. The liquid cup 4 is designed with separated liquid-storage chambers, which may make full usage of the space of the liquid cup 4. The atomization assembly 2 only needs to be provided with one liquid cup 4 to realize the diversification of flavors. It is understandable that a number of liquid-storage chambers 43 is the same as a number of first dividing walls 41, and the number of atomization cores 7 is the same as the number of liquid-storage chambers 43.

In some embodiments, the liquid cup 4 may include three first dividing walls 41. The three first dividing walls 41 divide the liquid cup 4 into three liquid-storage chambers 43. The liquid cup 4 may also include four first dividing walls 41. The four first dividing walls 41 divide the liquid cup 4 into four liquid-storage chambers 43. The number of first dividing walls 41 may be set according to the actual situation, and is not limited herein.

As shown in FIG. 1, FIG. 3, and FIG. 6, in some embodiments, the fixed seat 13 is defined with a first airflow inlet 135. The atomization assembly 2 is defined with an air outlet passage communicating with the first airflow inlet 135. The liquid cup 4 further includes second dividing walls 42, each of the second dividing walls 42 is arranged between each two adjacent first dividing walls 41. Each of the second dividing walls 42 and corresponding two adjacent first dividing walls 41 are enclosed to form an airflow channel 44. The airflow channel 44 is part of the air outlet passage.

In these embodiments, each of the second dividing walls 42, the corresponding two adjacent first dividing walls 41, and the side wall of the liquid cup 4 are enclosed to form the liquid-storage chambers 43. The airflow channels 44 is arranged one to one with the liquid-storage chambers 43. The liquid cup 4 is defined with independent liquid-storage chambers 43 and independent airflow channels 44. The airflow channels 44 occupy only a small portion of the space of the liquid cup 4. In this way, an airway is arranged in the liquid cup 4 without an additional structure, the space utilization rate of the liquid cup 4 is effectively improved, so that the liquid cup 4 with a same volume is capable of storing a larger volume of substance. The independent design of the airflow channels 44 may also effectively avoid the problem of flavour mixing.

In some embodiments, the supporting assembly 18 is defined with an air inlet passage communicating with outside of the electronic atomization device 100. The first airflow inlet 135 is communicating with both the air inlet passage and the air outlet passage. The external air may flow sequentially through the air inlet passage and the first airflow inlet 135 into the air outlet passage.

In some embodiments, the fixed seat 13 is further defined with a mounting hole 136. The mounting hole 136 is configured to mount a liquid-absorbing member (not shown). The liquid-absorbing member may be liquid-absorbing cotton, etc. In some embodiments, the mounting hole 136 is defined in the middle of the base 131. The first airflow inlet 135 is defined adjacent to the mounting hole 136. The first holes 133 are evenly distributed around the mounting hole 136. The second holes 134 are defined at an edge of the base 131.

In some embodiments, the contour of the liquid cup 4 is in the shape of a cylinder. The first dividing walls 41 extend from a central axis of the liquid cup 4 to the side wall of the liquid cup 4. The second dividing walls 42 are arranged close to the central axis of the liquid cup 4, so that the airflow channel 44 is capable of being located in the middle of the liquid cup 4.

In some embodiments, the plurality of first dividing walls 41 are connected to each other at the central axis of the liquid cup 4. The plurality of second dividing walls 42 are collectively enclosed to form a substantially cylinder at the center of the liquid cup 4. It is understandable that the plurality of first dividing walls 41 divide the cylinder enclosed by the plurality of second dividing walls 42 into the plurality of airflow channels 44.

As shown in FIG. 1 and FIG. 2, in some embodiments, the atomization assembly 2 further includes a suction nozzle 1. The suction nozzle 1 is arranged at an end of the upper housing 10 away from the rotating assembly 6. The air outlet passage includes a central hole 27 defined in the suction nozzle 1. The suction nozzle 1 is arranged opposite to the liquid cup 4. The airflow channels 44 are directly opposite to the central hole 27 of the suction nozzle 1, the aerosol formed by heating and atomizing the substance is capable of flowing from the airflow channels 44 to the central hole 27 of the suction nozzle 1 in a relatively smooth manner, which effectively reduces the chances of forming condensate and improves the use experience.

In some embodiments, a suction nozzle sealing-member 3 is arranged between the suction nozzle 1 and the liquid cup 4. The suction nozzle sealing-member 3 includes a second end toward the liquid cup 4. The second end of the suction nozzle sealing-member 3 is configured to seal the liquid-storage chambers 43. The air outlet passage includes a through hole 32 defined in the suction nozzle sealing-member 3. The through hole 32 of the suction nozzle sealing-member 3 is configured to communicate the airflow channels 44 and the central hole 27 of the suction nozzle 1.

In some embodiments, a second liquid-absorbing member 31 is arranged in the suction nozzle sealing-member 3. The suction nozzle sealing-member 3 includes a third side toward the suction nozzle 1. The second liquid-absorbing member 31 is arranged on the third side of the suction nozzle sealing-member 3. The suction nozzle sealing-member 3 may be made of a silicone material. The second liquid-absorbing member 31 may be a liquid-absorbing cotton, etc. The second liquid-absorbing member 31 is configured to prevent the substance stored in the liquid-storage chambers 43 from leaking out of the suction nozzle 1.

The working principles of the electronic atomization device 100 provided in the present disclosure are as follow. When in use, the user rotates the middle portion 112 of the rotating seat 11, the rotating seat 11 drives the atomization assembly 2 to rotate relative to the fixed seat 13. When the electrically conductive pin 8 on the atomization assembly 2 rotates to the positioning hole 83 aligned with the spring-loaded pin 16 that protrudes on the fixed seat 13, a top end of the spring-loaded pin 16 extends into the positioning hole 83 of the electrically conductive pin 8, and the atomization core 7 connected to the electrically conductive pin 8 is power on and starts working. The atomization core 7 heats and atomizes the substance in the liquid-storage chamber 43 where the atomization core 7 is located to form the aerosol. The aerosol flows into the corresponding airflow channel 44 from the bottom of the atomization core 7 and flows into the suction nozzle 1 approximately vertically, and may be sucked by the user. The user can also rotate the upper housing 10 fixedly connected to the rotating seat 11 to realize the rotation of the atomization assembly 2 relative to the fixed seat 13.

As shown in FIG. 3, in some embodiments, the bottom wall of the liquid cup 4 is defined with a plurality of atomization core receptacles 45. Each of the atomization core receptacles 45 is communicating with both a corresponding liquid-storage chamber 43 and a corresponding airflow channel 44. The plurality of atomization cores 7 are accommodated in the atomization core receptacles 45 one to one. Each of the atomization cores 7 is configured to heat and atomize the substance in the corresponding liquid-storage chamber 43 to form the aerosol. The aerosol flows through the corresponding airflow channel 44.

The atomization core 7 includes a fourth surface toward the liquid-storage chamber 43. The substance in the liquid-storage chamber 43 may penetrate into the atomization core 7 through the fourth surface of the atomization core 7. The atomization core 7 includes a fifth surface away from the liquid-storage chamber 43. The atomization core 7 heats and atomizes the substance to form the aerosol flowing into the corresponding airflow channel 44 through the fifth surface of the atomization core 7, and being sucked by the user through the central hole 27 of the suction nozzle 1.

In some embodiments, the bottom wall of the liquid cup 4 is defined with a plurality of accommodating holes 46. Each side of each of the atomization core receptacles 45 is defined with an accommodating hole 46. A pair of electrically conductive pins 8 corresponding to the atomization core 7 are respectively mounted in corresponding two accommodating holes 46. Pins of the atomization core 7 are exposed from the atomization core receptacle 45, and are electrically connected to the corresponding pair of electrically conductive pins 8.

As shown in FIG. 1 and FIG. 2, in some embodiments, the electronic atomization device 100 further includes the supporting assembly 18. The supporting assembly 18 includes a lower housing 24 and a frame 17 fixed in the lower housing 24. The lower housing 24 is sleeved on an end of the rotating seat 11 away from the atomization assembly 2. The frame 17 is fixedly connected to the fixed seat 13. The frame 17 includes a top side toward the fixed seat 13. The spring-loaded pins 16 are mounted on the top side.

In some embodiments, the lower housing 24 is sleeved on the lower connecting portion 113. An edge of the lower housing 24 is adjacent to or contacts the second convex edge 1122. In some embodiments, the lower connecting portion 113 may be fixedly attached to the lower housing 24 by means of gluing, clamping, threading, or screwing. The frame 17 extends from an end of the lower housing 24 close to the rotating assembly 6 to the other end of the lower housing 24 away from the rotating assembly 6. The fixing member 15 includes a second end passing through the first hole 133. The frame 17 includes a third end toward the fixed seat 13. The second end of the fixing member 15 is fixedly mounted at the third end of the frame 17. An end of the spring-loaded pin 16 is fixedly mounted on the frame 17, and the other end of the spring-loaded pin 16 passes through the second hole 134 and protrudes on the surface of the fixed seat 13.

In some embodiments, the supporting assembly 18 further includes a battery cell 23 fixedly mounted in the lower housing 24. The battery cell 23 is electrically connected to the spring-loaded pins 16 for supplying power to the atomization assembly 2. In some embodiments, the battery cell 23 is fixedly mounted on the frame 17.

In these embodiments, the spring-loaded pins 16 and the electrically conductive pins 8 are capable of realizing the function of positioning when rotating. The battery cell 23 may supply power to the atomization assembly 2 through the spring-loaded pins 16. In this way, the spring-loaded pins 16 have the functions of positioning and conductive simultaneously, and the electronic atomization device 100 does not need to set positioning assemblies and conductive assemblies additionally, thereby effectively reducing production cost.

In some embodiments, the supporting assembly 18 further includes a bottom cover 22 fixed on an end of the lower housing 24 away from the rotating assembly 6. The lower housing 24 and the bottom cover 22 are enclosed to form a cavity. Both the frame 17 and the battery cell 23 are accommodated in the cavity.

In some embodiments, the supporting assembly 18 further includes an airflow sensing assembly 19 and a control board 20, which are fixedly mounted on the frame 17. A button 21 is arranged on the control board 20. Both the airflow sensing assembly 19 and the control board 20 are electrically connected to the battery cell 23. The airflow sensing assembly 19 is arranged at the end of the frame 17 close to the rotating assembly 6, and is configured to sensing the air flowing into the air inlet passage. The user can control operating states of the electronic atomization device 100 by pressing the button 21.

In some embodiments, a third liquid-absorbing member 172 is arranged between the airflow sensing assembly 19 and the frame 17. The third liquid-absorbing member 172 may be a liquid-absorbing cotton, etc. The third liquid-absorbing member 172 may prevent the substance from leaking into the lower housing 24, avoiding the substance from causing damage to devices such as the battery cell 23 and the control board 20.

In some embodiments, the frame 17 is defined with a second airflow inlet 171. The fixed seat 13 is defined with the first airflow inlet 135, and the second airflow inlet 171 is arranged opposite to the first airflow inlet 135. In some embodiments, the frame 17 includes a fourth end toward the rotating assembly 6. The second airflow inlet 171 is defined at the fourth end of the frame 17 and is located in the air inlet passage. The second airflow inlet 171 is communicating with the first airflow inlet 135. A first sealing ring 12 is arranged at a place where the rotating seat 11 and the lower housing 24 are sleeved. A second sealing ring 14 is arranged at a place where the first airflow inlet 135 and the second airflow inlet 171 are communicating.

In some embodiments, an outer wall of the lower connecting portion 113 may be defined with a groove, and the first sealing ring 12 may be accommodated in the groove. Alternatively, a groove may be defined at the lower housing 24 corresponding to the lower connecting portion 113, and the first sealing ring 12 may be accommodated in the groove. The base 131 may be defined with a groove at a place where the first airflow inlet 135 is defined, and the second sealing ring 14 may be accommodated in the groove. Alternatively, the frame 17 may be defined with a groove at a place where the second airflow inlet 171 is defined, and the second sealing ring 14 may be accommodated in the groove.

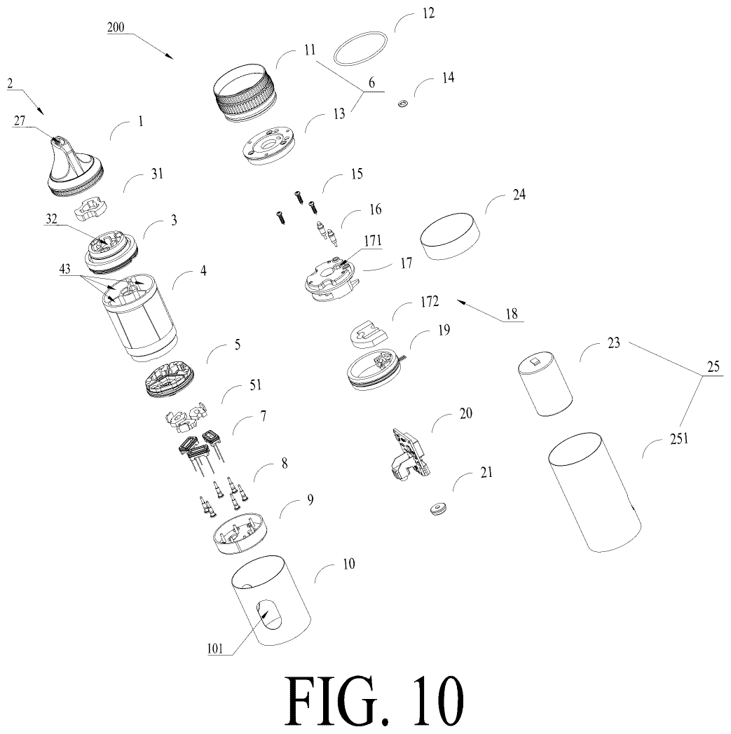

FIG. 10 is an exploded view of an electronic atomization device 200 according to some embodiments of the present disclosure. As shown in FIG. 10, in some embodiments, the electronic atomization device 200 includes an atomization assembly 2, a rotating assembly 6, a supporting assembly 18, and a battery assembly 25. The battery assembly 25 includes a battery housing 251 and a battery cell 23 mounted in the battery housing 251. A lower housing 24 is connected to the battery housing 25. The battery cell 23 is electrically connected to spring-loaded pins 16 for supplying power to the atomization assembly 2.

The atomization assembly 2 and the rotating assembly 6 may be the same as the electronic atomization device 100. The difference with the electronic atomization device 100 is that the atomization assembly 2, the rotating assembly 6, the supporting assembly 18, and the battery assembly 25 of the electronic atomization device 200 are connected sequentially. The supporting assembly 18 includes the lower housing 24 and the frame 17 arranged in the lower housing 24. The battery housing 251 is connected to an end of the lower housing 24 away from the rotating assembly 6. The battery cell 23 is electrically connected to the spring-loaded pins 16 for supplying power to the atomization core 7 through the spring-loaded pins 16.

In some embodiments, the battery housing 251 may be connected to the lower housing 24 by means of threading or magnetic attraction. When the battery housing 251 is connected to the lower housing 24 by means of threading, both the battery housing 251 and the lower housing 24 may have threaded interfaces that match each other, such as 510 threaded interfaces, etc. A threaded member with functions of conductive and air path communicate may be arranged between the battery assembly 25 and the supporting assembly 18, thereby realizing the electrical connection and air path communication between the battery assembly 25 and the supporting assembly 18. When the battery housing 251 is connected to the lower housing 24 by means of magnetic attraction, magnetic members matching each other may be arranged between the battery assembly 25 and the supporting assembly 18. An electrode and an air guiding hole may be arranged between the battery assembly 25 and the supporting assembly 18, thereby realizing the electrical connection and air path communication between the battery assembly 25 and the supporting assembly 18. It is understandable that the battery assembly 25 is connected to the supporting assembly 18 by means of a detachable connection, so that the battery assembly 25 is easily replaced.

In some embodiments, the battery assembly 25 may also include a control board 20 arranged with a button 21, and the control board 20 is mounted in the battery housing 251 and is electrically connected to the battery cell 23.

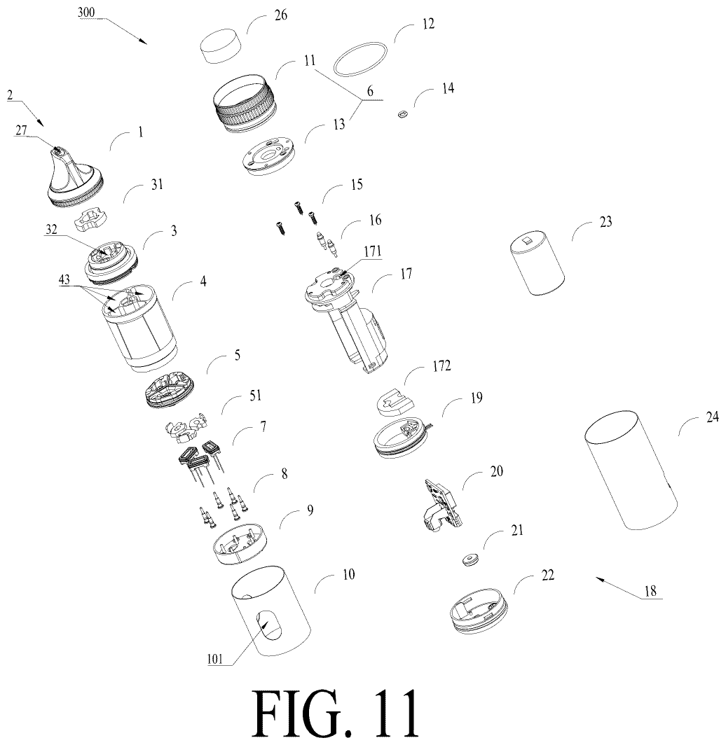

FIG. 11 is an exploded view of an electronic atomization device 300 according to some embodiments of the present disclosure. As shown in FIG. 11, in some embodiments, the difference with the electronic atomization device 100 is that, in the electronic atomization device 300, the rotating assembly 6 further includes a driving member 26. The driving member 26 is configured to drive one of the rotating seat 11 and the fixed seat 13 to rotate, so that the rotating seat 11 and the fixed seat 13 are capable of rotating relative to each other.

The driving member 26 is electrically connected to the battery cell 23 and the control board 20 respectively. The user can control the relative rotation of the rotating seat 11 and the fixed seat 13 by pressing the button 21. In some embodiments, the driving member 26 may drive the rotating seat 11 to rotate, may drive the fixed seat 13 to rotate, or may drive the rotating seat 11 and the fixed seat 13 to rotate along opposite directions respectively.

In some embodiments, the driving member 26 may include a driving shaft (not shown). The driving shaft is arranged in the middle of the rotating assembly 6, and is configured to drive the rotating seat 11 to rotate, or to drive the fixed seat 13 to rotate. The driving member 26 may also include a linkage member, such as a friction rod or a pinion, arranged between the driving shaft and the rotating assembly 6. The driving member 26 drives the rotating seat 11 or the fixed seat 13 to rotate by driving the linkage member.

In some embodiments, the driving member 26 may also include a passive shaft (not shown) connected to the driving shaft. When the driving shaft is configured to drive the rotating seat 11 to rotate along a direction, the passive shaft may be configured to drive the fixed seat 13 to rotate along an opposite direction. When the driving shaft is configured to drive the fixed seat 13 to rotate along a direction, the passive shaft may be configured to drive the rotating seat 11 to rotate along an opposite direction.

In some embodiments, the driving member 26 may also include a power device (not shown), such as a motor, etc., which is configured for supplying power to the driving shaft. The power device is electrically connected to the battery cell 23 and the control board 20 respectively.

In some embodiments, the driving member 26 may drive the upper housing 10 to rotate. The upper housing 10 drives the rotating seat 11 to rotate, so that the rotating seat 11 is capable of rotating relative to the fixed seat 13.

The present disclosure does not need to arrange the related rotating structure in the middle of the space where the liquid cup of the electronic atomization device is located, only an accommodating space is arranged below the liquid cup for arranging the rotating assembly. In this way, the space occupied by the rotating assembly may be effectively reduced, and the space utilization rate of the electronic atomization device is improved. The accommodating space may be set to be thinner to help reduce the occupied space, i.e., the rotating assembly may have a shorter height.

As shown in FIG. 1 and FIG. 2, in some embodiments, the embodiments of the present disclosure provide the electronic atomization device 100, and the electronic atomization device 100 includes the atomization assembly 2 and the rotating assembly 6. The atomization assembly 2 includes the liquid cup 4, the upper housing 10, and the plurality of atomization cores 7. The liquid cup 4 is fixedly mounted in the upper housing 10. The liquid cup 4 is defined with at least one liquid-storage chamber 43 for storing the substance. The plurality of atomization cores 7 are configured to be in fluid communication with the liquid-storage chamber 43 to heat and atomize the substance to form the aerosol. The rotating assembly 6 is arranged at the end of the upper housing 10. The rotating assembly 6 includes the rotating seat 11 and the fixed seat 13, and the rotating seat 11 and the fixed seat 13 are capable of rotating relative to each other. The rotating seat 11 and the fixed seat 13 are sleeved together. The rotating seat 11 is fixedly attached to the upper housing 10. The fixed seat 13 is configured to be fixedly attached to the supporting assembly 18, so that the atomization assembly 2 is capable of rotating relative to the supporting assembly 18.

As shown in FIG. 1 and FIG. 2, in some embodiments, the embodiments of the present disclosure provide the electronic atomization device 100, and the electronic atomization device 100 includes the atomization assembly 2, the rotating assembly 6, and the supporting assembly 18. The atomization assembly 2 is configured to heat and atomize the substance to form the aerosol. The atomization assembly 2 includes the upper housing 10. The rotating assembly 6 is arranged at the end of the upper housing 10. The rotating assembly 6 includes the rotating seat 11 and the fixed seat 13, and the rotating seat 11 and the fixed seat 13 are capable of rotating relative to each other. The rotating seat 11 and the fixed seat 13 are sleeved together. The rotating seat 11 is fixedly attached to the upper housing 10. The supporting assembly 18 includes the lower housing 24 and the frame 17 fixed in the lower housing 24. The lower housing 24 is sleeved on the end of the rotating seat 11 away from the atomization assembly 2. The frame 17 is fixedly connected to the fixed seat 13, so that the atomization assembly 2 and the supporting assembly 18 are capable of rotating relative to each other.

It should be noted that in the present disclosure, relational terms such as first and second are only used to distinguish one entity or operation from another entity or operation, and do not necessarily require or imply any actual relationship or sequence between the entities or operations. Further, the terms “include”, “comprise” or any other variation thereof are intended to cover non-exclusive inclusion, such that a process, method, article, or apparatus including a series of elements not only includes those elements, but also other elements not explicitly listed, or also includes elements inherent to such process, method, article, or apparatus. Without more restrictions, an element defined by the statement “including a . . . ” does not exclude the existence of other identical elements in the process, method, article, or apparatus including the element.

Although embodiments of the present disclosure have been shown and described, for those of ordinary skill in the art, it is understandable that a variety of variations, modifications, substitutions and variants may be made to these embodiments without departing from the principles and spirit of the present disclosure. The scope of the present disclosure is limited by the attached claims and their equivalents.

What is claimed is:

1. An electronic atomization device, comprising:
an atomization assembly, configured to heat and atomize a substance to form an aerosol and comprising an upper housing; and
a rotating assembly, arranged at an end of the upper housing and comprising a rotating seat and a fixed seat, wherein the rotating seat and the fixed seat are capable of rotating relative to each other, wherein the rotating seat is fixedly attached to the upper housing, wherein the rotating seat and the fixed seat are sleeved together, and wherein the fixed seat is configured to be fixedly attached to a supporting assembly, so that the atomization assembly is capable of rotating relative to the supporting assembly.

2. The electronic atomization device according to claim 1, wherein the rotating seat comprises an upper connecting portion and a lower connecting portion, wherein the upper connecting portion is fixedly attached to the upper housing, wherein the lower connecting portion has a first step portion, wherein the first step portion comprises a first surface; and
wherein the fixed seat comprises a base and a second step portion arranged on the base, wherein the second step portion comprises a second surface, wherein the second surface contacts the first surface, and wherein the first step portion and the second step portion are capable of rotatably sliding relative to each other along the first surface and the second surface, so that the rotating seat and the fixed seat rotate relative to each other.

3. The electronic atomization device according to claim 2, wherein the rotating seat further comprises a middle portion; wherein the upper connecting portion, the middle portion, and the lower connecting portion are connected in sequence; and
wherein the middle portion is convex relative to the upper connecting portion and the lower connecting portion, so that the middle portion comprises a first convex edge close to the upper connecting portion and a second convex edge close to the lower connecting portion; wherein the end of the upper housing is adjacent to or contacts the first convex edge, and wherein the second convex edge is configured to be adjacent to or contact the supporting assembly.

4. The electronic atomization device according to claim 3, wherein an outer surface of the middle portion is provided with a concave-convex pattern.

5. The electronic atomization device according to claim 1, wherein the fixed seat is defined with two or more first holes, and wherein the fixed seat is configured to be fixedly attached to the supporting assembly by fixing members passing through the first holes and being fixedly mounted on the supporting assembly.

6. The electronic atomization device according to claim 1, wherein the supporting assembly comprises two spring-loaded pins, wherein the atomization assembly further comprises a plurality of atomization cores and a plurality of pairs of electrically conductive pins, wherein each of the atomization cores is electrically connected to a corresponding pair of electrically conductive pins; and
wherein the two spring-loaded pins are capable of selectively contacting with a pair of electrically conductive pins in the plurality of pairs of electrically conductive pins by relative rotation of the rotating seat and the fixed seat, so that the spring-loaded pins are capable of being electrically connected to one of the atomization cores in the plurality of atomization cores.

7. The electronic atomization device according to claim 6, wherein the atomization assembly further comprises a liquid cup fixedly mounted in the upper housing, wherein the liquid cup is defined with at least one liquid-storage chamber for storing the substance, and wherein the plurality of atomization cores are configured to be in fluid communication with the liquid-storage chamber.

8. The electronic atomization device according to claim 7, wherein the fixed seat is defined with second holes, wherein each of the spring-loaded pins passes through one of the second holes and protrudes on a surface of the fixed seat; and
wherein the atomization assembly further comprises a first cover, wherein the liquid cup comprises a bottom end toward the rotating assembly, wherein the first cover is sleeved on the bottom end, and wherein the plurality of pairs of electrically conductive pins are fixedly mounted on the first cover.

9. The electronic atomization device according to claim 8, wherein at least one electrically conductive pin of a pair of electrically conductive pins is defined with a positioning hole, wherein the electrically conductive pin comprises a bottom side toward the rotating assembly, wherein the positioning hole is arranged on the bottom side; and
wherein when the two spring-loaded pins are in contact with a pair of electrically conductive pins in the plurality of pairs of electrically conductive pins, at least one spring-loaded pin of the two spring-loaded pins extends into the positioning hole of the electrically conductive pin.

10. The electronic atomization device according to claim 7, wherein the liquid cup comprises a plurality of first dividing walls, a side wall, and a bottom wall; wherein the first dividing walls and the side wall and the bottom wall of the liquid cup are enclosed to form a plurality of liquid-storage chambers, and wherein each of the plurality of liquid-storage chambers accommodates one of the plurality of atomization cores.

11. The electronic atomization device according to claim 10, wherein the fixed seat is defined with a first airflow inlet, wherein the atomization assembly is defined with an air outlet passage communicating with the first airflow inlet; and
wherein the liquid cup further comprises second dividing walls, wherein each of the second dividing walls is arranged between each two adjacent first dividing walls, wherein each of the second dividing walls and corresponding two adjacent first dividing walls are enclosed to form an airflow channel, and wherein the airflow channel is part of the air outlet passage.

12. The electronic atomization device according to claim 11, wherein a contour of the liquid cup is in a shape of a cylinder, wherein the first dividing walls extend from a central axis of the liquid cup to the side wall of the liquid cup; and
wherein the second dividing walls are arranged close to the central axis of the liquid cup, so that the airflow channel is capable of being located in the middle of the liquid cup.

13. The electronic atomization device according to claim 11, wherein the bottom wall of the liquid cup is defined with a plurality of atomization core receptacles; and
wherein each of the atomization core receptacles, which is configured to accommodate one of the atomization cores, is communicating with both a corresponding liquid-storage chamber and a corresponding airflow channel, so that the aerosol formed by the atomization core is capable of flowing through the corresponding airflow channel.

14. The electronic atomization device according to claim 6, wherein the electronic atomization device further comprises the supporting assembly, wherein the supporting assembly comprises a lower housing and a frame fixed in the lower housing, wherein the lower housing is sleeved on an end of the rotating seat away from the atomization assembly, wherein the frame is fixedly connected to the fixed seat, wherein the frame comprises a top side toward the fixed seat, and wherein the spring-loaded pins are mounted on the top side.

15. The electronic atomization device according to claim 14, wherein the supporting assembly further comprises a battery cell fixedly mounted in the lower housing, and wherein the battery cell is electrically connected to the spring-loaded pins for supplying power to the atomization assembly.

16. The electronic atomization device according to claim 14, wherein the electronic atomization device further comprises a battery assembly, wherein the battery assembly comprises a battery housing and a battery cell mounted in the battery housing, wherein the lower housing is connected to the battery housing, and wherein the battery cell is electrically connected to the spring-loaded pins for supplying power to the atomization assembly.

17. The electronic atomization device according to claim 14, wherein the frame is defined with a second airflow inlet, wherein the fixed seat is defined with a first airflow inlet, wherein the second airflow inlet is arranged opposite to the first airflow inlet, wherein a first sealing ring is arranged at a place where the rotating seat and the lower housing are sleeved, and wherein a second sealing ring is arranged at a place where the first airflow inlet and the second airflow inlet are communicating.

18. The electronic atomization device according to claim 1, wherein the rotating assembly further comprises a driving member; and wherein the driving member is configured to drive one of the rotating seat and the fixed seat to rotate, so that the rotating seat and the fixed seat is capable of rotating relative to each other.

19. An electronic atomization device, comprising:
an atomization assembly, comprising:
a liquid cup, an upper housing, and a plurality of atomization cores, wherein the liquid cup is fixedly mounted in the upper housing and is defined with at least one liquid-storage chamber for storing a substance, and wherein the plurality of atomization cores are configured to be in fluid communication with the liquid-storage chamber to heat and atomize the substance to form an aerosol; and
a rotating assembly, arranged at an end of the upper housing and comprising a rotating seat and a fixed seat, wherein the rotating seat and the fixed seat are capable of rotating relative to each other, wherein the rotating seat is fixedly attached to the upper housing, wherein the rotating seat and the fixed seat are sleeved together, and wherein the fixed seat is configured to be fixedly attached to a supporting assembly, so that the atomization assembly is capable of rotating relative to the supporting assembly.

20. An electronic atomization device, comprising:
an atomization assembly, configured to heat and atomize a substance to form an aerosol and comprising an upper housing;
a rotating assembly, arranged at an end of the upper housing and comprising a rotating seat and a fixed seat, wherein the rotating seat and the fixed seat are capable of rotating relative to each other, wherein the rotating seat is fixedly attached to the upper housing, and wherein the rotating seat and the fixed seat are sleeved together; and
a supporting assembly, comprising a lower housing and a frame fixed in the lower housing, wherein the lower housing is sleeved on an end of the rotating seat away from the atomization assembly, and wherein the frame is fixedly connected to the fixed seat, so that the atomization assembly is capable of rotating relative to the supporting assembly.
